(19) United States
(12) Patent Application Publication
(10) Pub. No.: US 2013/0305963 A1
(43) Pub. Date: Nov. 21, 2013

(54) Method of producing activated construction mixture

(71) Applicant: Vladlen Fridman, Naugatuck, CT (US)

(72) Inventor: Vladlen Fridman, Naugatuck, CT (US)

(21) Appl. No.: 13/476,003

(22) Filed: May 20, 2012

(51) Int. Cl. C04B 40/00; C04B 14/06; C04B 18/06

(52) U.S. Cl. 106/710; 106/638; 106/705

(57) ABSTRACT

In a method of producing an activated construction mixture including cement, water, additives and superplasticizer the activation is performed with dimensionless criteria Reynolds and Power numbers within the limits of 20-800 and 4.0-0.1 respectively for increasing water adsorption with calcium silicate hydrate colloid formation and accelerating cement hydration.

### BACKGROUND OF THE INVENTION

The present invention relates to methods of producing construction mixture with its mechanical activation.

Some authors, Lindström and B. Westerberg “Fine Ground Cement in Concrete-Properties and Prospects,” ACI Materials Journal 100 (5) (2003), pp. 398-406; K.-B. Park, J. L. Plawsky, H. Littman, J. D. Paccione “Mortar properties obtained by dry premixing of cementitious materials and sand in a spout-fluid bed mixer” Cement, Concrete Research 36 (4) (2006) pp. 728-734; Rakesh Kumar, Sanjay Kumar, S. P. Mehrotra, “Towards sustainable solutions for fly ash through mechanical activation,” Resources Conservation & Recycling 52 (2007). pp. 157-179; Zivko Sekulic, Svetlana Popov, Mirjana Duricic, Aleksandra Rosic, “Mechanical activation of cement with addition of fly ash,” Materials letters 39 (1999), pp. 115-121, Elsevier, designate the process of fine grinding of cement with and without additives by the term “mechanical activation”. In this technique the increase of water adsorption is a result of a particle size diminution and raise of total surface of cement and water interaction. These methods usually require 4-5 times more energy than method according to the present invention.

The methods, where cement-water suspension is subject to mechanical forces action are closer to present invention. Hodson [U.S. Pat. No. 4,225,247] use the term “high energy mixing” to define any type of mixing technique which accomplishes or effectively forces more intimate contact between water and cement particles. Hodson suggests a special mixing assembly structured to provide a flow of the cement-water mixture concurrently in a direction around the central axis of container, whereby shear flow of the mixed material is established.

Zimmerman [U.S. Pat. No. 7,422,359] use turbine mixer with high speed rotating mixing plate to break up water and cement into small particles that enhances the hydration of cement and increase air content in the resulting cement paste. The cement paste is then conveyed to a mixing auger to be combined with aggregates to create concrete mix.

H. Hodne, A. Saasen, A. B. O'Hagan, S. O. Wick as disclosed in “Effect of time and shear energy on the rheological behavior of oil well cement slurries” , Cement and Concrete Research 30 (2000) pp. 1759-1766, used the similar technique. They carried out activation while cement was being mixed with water (W/C ratio of 0.38), by means of increasing mixing shear rate. They employed three types of propeller blades of various sizes and raised the speed up to 12,000 rpm. Authors studied the gel strength by measuring shear stress of high speed mixed slurries and realized that it increases with input of mixing energy increasing. The net specific energy consumption for construction and oil well cement slurries was 1.8-7.6 Kj/kg. In the method of present invention the level of net specific consumed energy for similar slurries (W/C equals 0.36) was no less than 30 Kj/kg that creates more favorable conditions for gel formation.

Marshal L. Brown, H. M. Jennings, W. B. Ledbetter, “On the generation of heat during the mixing of cement pastes,” Cement Concrete Research 20 (1990), pp. 471-474, carried out the high-speed shear mixing of low water/cement ratio pastes (W/C=0.24) with the admixture of superplasticizer 1.5% of cement mass. The mixer with axial impeller 178 mm diameter, turned at rate of 1575 rpm was used for this purpose in comparing with conventional mixer with the paddle of epicyclical type. Both kinds of mixing were continued 4 minutes. Authors achieved increase in temperature of mixture prepared in high-speed shear mixer 22-24° C. in comparing with paddle mixer as a result of friction. They didn't realize difference in degree of cement hydration for both mixtures. The bound water content was 0.6 percent for the shear-mixed and paddle mixed pastes.

Gary R. Mass, “Premixed Cement Paste,” Concrete International 11 (1989), pp. 82-85, proposed a method of premixing the cement-water suspension in a high-speed mixer before mixing it with fine and coarse aggregates in an ordinary mixer. He used vertical stationary blades attached to interior wall of bowl to provide concurrent flow of mixture. Given the optimal combination of W/C ratio, speed and mixing time (unspecified in the article), it was achieved a 20% strength increase in 28 days by the optimal combination of activation parameters.

The authors of the above mentioned methods have approached to the problem of the activation mixture of cement and water and some of them attained results of possible concrete strength increase about 20%. Meanwhile the mechanical activation of the cement based mixture may be accomplished more effectively.

Applying the mechanical energy to the activation process fulfilled in the activating assembly requires considering effectiveness of energy use that depends on the flow of the mixture in the activation process. Theoretically the flow of activated mixture may be more or less turbulent as well as close to laminar. The last variant is more energy effective. The dimensionless criteria Reynolds number and Power number precisely reflect the character of flow of activated mixture and effectiveness of the power input in this processes as disclosed in P. K. Biswas, K. M. Godiwalla, D. Sanyal, S. C. Dev, “A simple technique for measurement of apparent viscosity of slurries: sand-water system,” Materials and Design 23 (2002), pp. 511-519.

The authors of the works dedicated to mechanical activation of cement based mixtures did not consider the activation processes from this point of view. The described above machinery and processes allow to assume that most of these techniques provide rather turbulent than close to laminar flow of the activated mixture aiming to use high velocity and concurrent flow of mixture provoking increase in air entraining. Turbulent flow is less energy effective.

Moreover, all of the authors have activated the cement-water suspension without fine aggregate (sand). K.-B. Park method cited above is exceptional. By this method dry cement-sand mix is activated in the special “spout-fluid bed” activator before adding water. It is not in accordance with the present invention where water is necessary ingredient in the process of mechanical activation. Meanwhile the fine aggregate (sand) effectively dissipates applied energy from the rotating blades through entire mixture. The hard abrasive particles of sand in high velocity conditions increase shear stresses on the surface of cement grains promoting their physical and chemical activity with respect to water molecules.

Previously, author established the level of reduction in flowability of activated cement-sand mortars as the first indicator of the activation as disclosed in, V. V. Fridman, K. M. Katz, “Method of producing of agitated mineral binder,” Certificate of Invention, USSR #1668344 8/1991. This is one of external signs of the water adsorption by the activated cement surface. The frictional heating of the mixture is the second phenomenon of the process, which were used as a control parameter of the process in V. V. Fridman, F. M. Krantov, I. M. Reznikov, “Metod V. V. Fridman for producing activated construction mixture” Patent #2017701, Russian Federation, 8/1994. The U.S. Pat. No. 5,443,313 uses the level of specific power and energy consumption required for activation as a parameter of process also. But this requirement does not establish level of useful energy for mechanical activation. It is necessary to consider the indexes characterizing the flow of mixture in the activation process and effectiveness of power input.

Such indexes are chosen in the present invention.

### SUMMARY OF THE INVENTION

Accordingly, it is an object of the present invention to provide a method of producing activated construction mixture which is a further improvement of the existing methods.

In keeping with this object and with others which will become apparent hereinafter, the main feature of the present invention resides in a method of producing an activated construction mixture of components including cement, water, additives and a superplasticizer with a mechanical activation comprising the steps of introducing the components into an activating assembly providing specific consumed power from 30 to 600 wt/kg and specific energy expenditure from 5 to 400 Kj/kg and mechanically activating the components in the activating assembly; measuring parameters of the mechanical activation and determining dimensionless criteria Reynolds and Power numbers used as a generalized parameters for providing a substantially laminar flow of a mixture of the components during the mechanical activation; and selecting for the mechanical activation said numbers within the limits 20-800 and 4.0-0.1 respectively, thus increasing water adsorption with calcium silicate hydrate colloid formation and thereby accelerating cement hydration.

With the parameters of the activation chosen according to the present invention the quantity of cement may be reduced up to 50% with substitution by fly ash.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings and tables.

### BRIEF DESCRIPTION OF DRAWINGS AND TABLES

FIG. 1 shows a penetration resistance development (Test #17, Re_{average}=777, Np_{average}=0.1);

FIG. 2 shows an acceleration of the penetration resistance development (Re_{average}=110.5, Np_{average}=0.856);

FIG. 3 shows compression strength of concrete made by conventional mixing (C) and with activated (A) mortar components with partial substitution cement by fly ash up to 50%;

FIG. 4 shows schematically an apparatus for producing activated construction mixture in accordance with the present invention.

Table 1 shows the examples of activated mixtures, general parameters of activation and observations (average values);

Table 1a shows the construction purposes of activated mixtures;

Table 2 shows the example of activation process monitoring, including measured and calculated parameters;

Table 3 shows the results of calculation of the production scale activator.

### DESCRIPTION OF THE PREFERRED EMBODIMENTS

In accordance with the invention, a method of producing an activated construction mixture of components including cement, water, additives and a superplasticizer with a mechanical activation is proposed.

The inventive method include introducing the components into an activating assembly providing specific consumed power from 30 to 600 wt/kg and specific energy expenditure from 5 to 400 Kj/kg and mechanically activating the components in the activating assembly. The parameters of the mechanical activation are then measured, and dimensionless criteria Reynolds and Power numbers used as generalized parameters are determined for providing a substantially laminar flow of a mixture of the components during the mechanical activation. Then for the mechanical activation these numbers are selected within the limits 20-800 and 4.0-0.1 respectively, thus increasing water adsorption with calcium silicate hydrate colloid formation and thereby accelerating cement hydration.

The results of tests in Tables 1, 2 show that the dimensionless criteria Reynolds and Power numbers are the parameters generalizing the process of mechanical activation and exactly reflecting the flow of activated mixture and effectiveness of power usage.

The present invention creates conditions for stimulation water adsorption by the surface of solid particles of the mixture wherein the formation of the Calcium Silicate Hydrate colloid (C—S—H gel) in full or partial volume of the cement-water matrix will be attained in several minutes of activation. The visible without magnifying syneresis when some of superplasticizers are used is the proof of C—S—H gel formation. Syneresis is a discharge of water typical for colloids. In activated cement-water and cement-sand-water mixtures this phenomenon is nearly matching to the period of setting, starting from the penetration resistance 500 psi and ending at 4000 psi which is measured according to ASTM C 403/C403M-05.

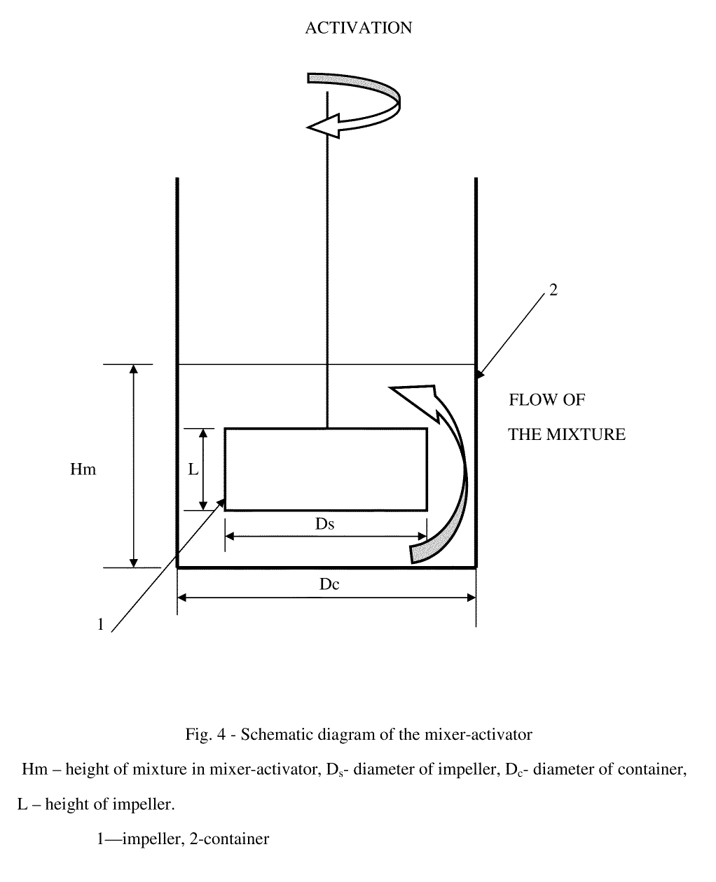

In the present invention the introducing and mechanically activating can include introducing the components into the activating assembly as shown in FIG. 4 having a container 1 with a rotating paddle 2 providing the specific consumed power.

In accordance with the inventive method also the cement hydration can include 3-5° C. under sea water and subzero on air conditions.

In the method of the invention the additives can include a mineral additive comprising cementitious materials with low hydraulic activity partly substituting cement, ettringite forming additive for shrinkage compensation, and pigments.

In the inventive method it is possible to provide introduction of the superplasticizer at an end of the activation for achieving a required flowability of the mixture without bleeding and segregation, and introduction partly during activation for continuation of the activation when an acceleration of water adsorption lowers a mixture flow.

In the inventive method it is possible to provide using in the mixture also sand with the required cement to sand ratio and with a partial substitution of cement by a component selected from the groups consisting of fly ash and fly ash with lime, and adding at an end of the activation of the superplasticizer and a gas-forming admixture to provide ending of expansion and start setting the activated mixture simultaneously for production of a cellular concrete having a reduced capillary flow.

In the inventive method it is possible to provide changing a volume of the activated mixture by proportionally changing geometric parameters of the activating assembly while maintaining constant a net specific power and values of the criteria Reynolds and Power numbers for each particular task and mixture.

Finally, the inventive method can further comprise forming the activating assembly as a small scale working prototype of a production scale activating assembly, monitoring a temperature of the activated mixture, power consumption and rotor rotation parameters with and without a mixture by a sensor and measuring devices, and inputting running values of said parameters and geometrical parameters of the activating assembly as constants and outputting running and average values of measured and calculated parameters including net power consumption, apparent dynamic viscosity and the dimensionless criteria Reynolds and Power numbers by a computer device.

Examples of activation are presented herein below, and boundary conditions for the method of activation according actual invention are explained.

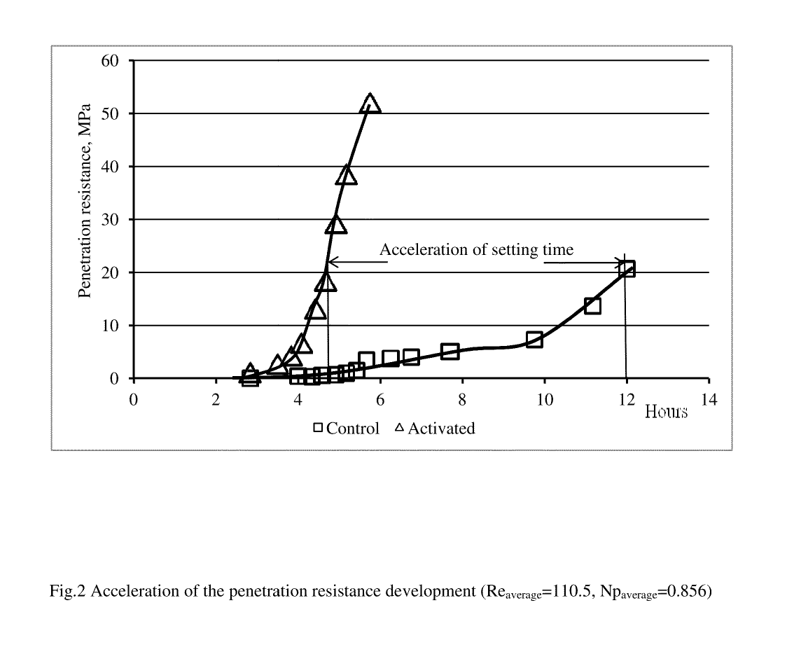

The signs of the activation process fulfilled according to the present invention may occur in short time after the end of activation (data shown in Table 1):
1. Reduction or absence of the water bleeding in comparison with the control non-activated sample of the same ingredients and proportions is observed. The bleeding of water is observed at the time before initial setting starts and reflects the capability of activated mixture to absorb water.
2. Developing of penetration resistance of activated mixtures is more active than non-activated one as a result of increased water adsorption and accelerated cement hydration in the conditions of reduced flow turbulence. The setting time acceleration was determined using the results of penetration resistance tests as shown on the FIG. 2.

In table 1 the examples of mixtures with different C/S/W (Cement/Sand/Water) proportions as well as conditions of activation and resulting parameters—apparent dynamic viscosity, Reynolds and Power numbers, after averaging monitoring data are given. The acceleration of setting time obtained from the curves of the penetration resistance development, and bleeding level observed just after mixture preparation are shown also in the same table for evaluation of effectiveness of each variant of activation.

Tests 11 and 17 (Table 1) reflects the boundary conditions for the present invention.

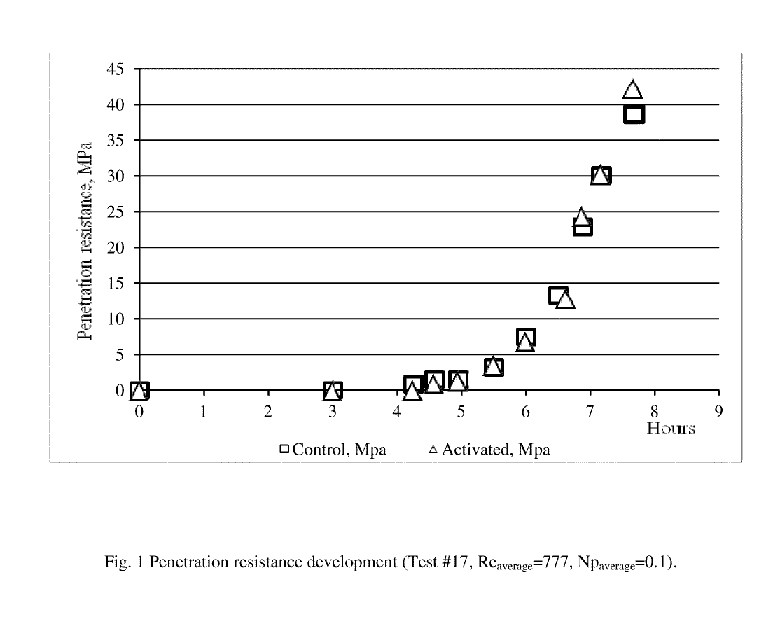

Activation is not effective in the situation where average values of Reynolds and Power numbers are equal 777 and 0.1 respectively (Table 1, test 17). The parameters of the test #17 are considered as upper boundary conditions. This level of turbulence isn't favorable for C—S—H gel formation. The bleeding indexes of activated and non-activated mixtures are equal, i.e. no difference in water absorption. There is no difference in the development of the penetration resistance for activated and non-activated mixtures (FIG. 1). Such activation does not accelerate the cement hydration.

The test 11, Table 1 reflects the lowest boundary situation Re=21.4, Np=3.47. There is acceleration of the penetration resistance development about 7 hours and there is no bleeding in activated mixture. This process is very close to fully laminar (Re≦10), but requires about 17 min to attain these results. The similar results for example in the tests #5, #20 require 4-5 min of activation. Therefore processes characterized with Reynolds number equal to 20 or less and Power numbers equal to 4.0 or greater values cannot be acceptable because they are lowering productivity of activation and preconsidered as lower boundary conditions in the present invention.

The principle of close to, substantially laminar flow is appropriate for the mixtures without sand as well. The result of activation of cement-water paste (Table 1, test ##19,20) is pretty noticeable (because bleeding of this no sand mixture activated during 4.5-6.0 min. was reduced 2.6-6.5 times comparing with control non-activated one, the acceleration of the penetration resistance in comparison with non-activated paste is about 1.3-2.0 hours but much less effective comparing with any cement-sand-water composition (Table 1, tests ##08,5,11,22,18) where the acceleration of penetration resistance was from 3.0 to 7 hours and zero of bleeding.

In the Table 1a the mixtures for the construction purposes are presented.

### The Physical Basis of the Activation Process

The necessity to control the flow regime of the mixture developing in activator and effectiveness of energy usage requires considering additional parameters to calculate Reynolds and Power numbers. This also allows transferring the technological process fulfilled on the small scale activator to big production scale machine keeping the same levels of these criteria. It requires to consider some groups of parameters: geometrical parameters such as diameter of impellor—Dₛ (m), height of blade—L (m), diameter of container—D_{c} (m) and height of mixture in container—Hₘ (m); physical parameters such as net power of activation—ΔP (watt) and total power input—P (watt), net energy of activation—ΔE and total input of energy E (joules), as well as velocity of impellor—N (rpm or rps).

Physical parameters values of the turned on empty activator labeled here as X₀, the current values of them taken in the process of activation are labeled as Xₜ. The present invention is based on experiments with multiple variations of these parameters during the activation of construction mixtures prepared with different proportions of cement, sand and water as well as with variety of impellors and their rotational speed.

Formulas for above mentioned dimensionless criteria to control their flow during the activation are formulas for stirred vessel (P. K. Biswas, K. M. Godiwalla, D. Sanyal, S. C. Dev “A simple technique for measurement of apparent viscosity of slurries: sand-water system”, Materials & Design, Vol. 23, pp. 511-519, 2002, India Elsevier Science Ltd.):

Re=(ρNₜDₛ²)/η (1)

Nₚ=ΔP/(ρNₜ³Dₛ⁵), (2)

where ρ is a density of the mixture in kg per cu. m, Nₜ is a speed of impeller in rps (revolutions per second), Dₛ—diameter of impeller in m, η=apparent dynamic viscosity in Pa·s (Pascal-second), ΔP—net power in watt.

In the present invention the mixer-activator considered as a kind of rotational viscometer. It creates a possibility to use equations (1) and (2) from (E. Freire et al. “Process ability of PVDF/PMMA blends studied by torque rheometry,” Materials Science and Engineering C 29, pp. 657-661, Elsevier 2009), received from Margules equation to calculate the dynamic viscosity value using formula:

η=τ/γ, (3)

where τ is shear stress in N/m², γ is shear rate in sec⁻¹.

Thus all these values may be calculated having the geometrical parameters of activator (R_{c}, Rₛ and L) mentioned above as well as the data of rotation velocity (Nₜ) and net Power (ΔP=Pₜ−P₀) measured during the process of activation.

The equation for dynamic viscosity is valid for rotational viscometers with the rotated cylinder or blades immersed into liquid. In the present invention the main apparatus consists of the cylinder cup and impellor with straight or skewed blades. The calculated dynamic viscosity (η) named as “apparent dynamic viscosity” of the mixture in the process of activation is a result of inertial forces action, developing into mixture, and consequently may be used as a denominator in the formula of Reynolds number.

The determination of measured parameters such as temperature of mixture in ° C., the velocity of rotation in rps, the power consumption in wt as well as calculated parameters: net torque (ΔT) in Nm (Newton-meter), apparent dynamic viscosity (η) in Pa·s, and dimensionless criteria Reynolds number and Power number was fulfilled every 6-10 seconds of activation. In the Table 2 some of them and average values are shown.

Data of the batch and observation are as follows:

Mixture proportioning: Cement/Sand/Water=1/2/0.39, superplasticizer 0.87% of cement quantity added in activated mixture. Activated plasticized mixture had no bleeding. Syneresis appeared in 3 hours after activation. The penetration resistance development for the activated mixture is shown on FIG. 2.

### Calculation of Production Scale Activator

The results of calculation of the production scale (p.s.) activator are presented in Table 3. Example is based on the data of test #5, Table 1 have gotten with the small scale (s.s.) activator. Production scale activator 0.1 cu·m of the activated mixture volume is intended for roof tile producing.

The geometrical parameters are calculated by geometrical proportions.

The rotational velocity N, rps calculated from the conditions: 1-st Re_{s.s.}=Re_{p.s.} and 2-nd Np_{s.s.}=Np_{p.s.}, and average result in rps is shown in table 3.

Therefore the velocity of impeller of the production scale activator should be 8.556×60=513 rpm, volume activated mixture=100 liters, and net power consumption 27.8 Kwt.

The following are the advantages of mechanical activation construction mixture with the method according to present invention.

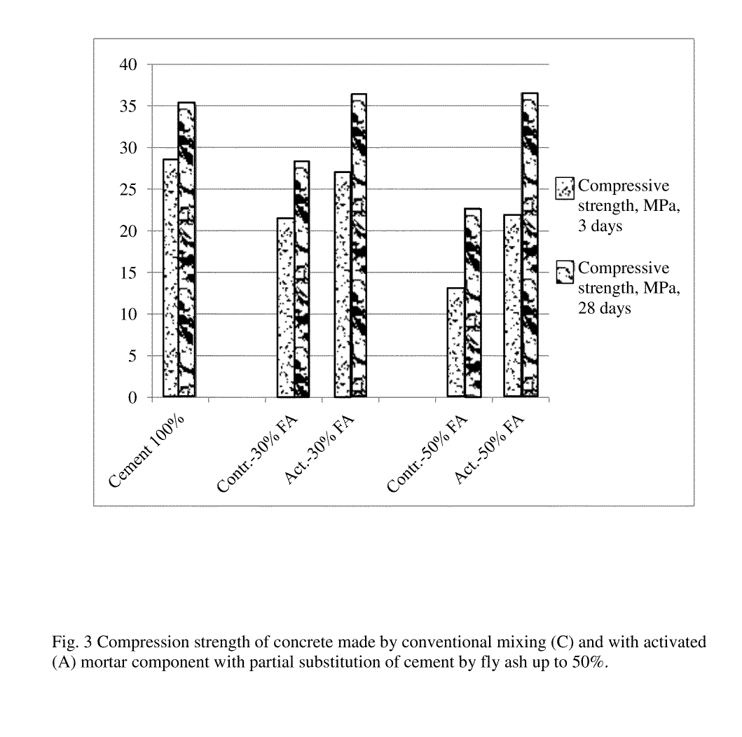

Inventor's investigations show, that after 3-5 minutes of mechanical activation in according to the present invention with substantially laminar flow of mixture the properties of mortars and concrete with the activated mortar component are drastically altered. Such activation accelerates cement hydration and helps to reduce cement quantity by 30-50%, with substituting by fly ash. Some results of these tests are given on FIG. 3.

With the increased quantity of C—S—H gel coloring pigments can be used as effectively as in plastics. Concrete with activated mortar component is non-permeable and possesses increased deformability. These benefits are achievable if the parameters of the mechanical activation are held in accordance with the present invention.

Flow of mixture in the process of mechanical activation has to be close to laminar with the dimensionless criteria Reynolds and Power numbers characterized by average values of these numbers within the limits of 20-800 and 4.0-0.1 respectively. These conditions create the opportunity to transform full volume of the cement-water matrix to Calcium Silicate Hydrate colloid (C—S—H gel) during short time of activation. The cellular concrete made according to present method with C—S—H gel formation in the full volume of cement-water matrix show reduced capillary flow.

There is significant change in properties of water in boundary layers as a result of activation according to present invention, including freezing temperature. Deryagin theory (Deryagin B. V., Churaev N. V., Zorin Z. M., “Structure and properties of boundary layers of water”, Izvestiya Akademii Nauk SSSR, Physical Chemistry, No. 8(1982) pp. 1507-1517) states that Van-der Waals forces, electrostatic forces and hydrogen bonds of water molecules to atoms of solid substrate are responsible for these phenomena. Activation according to present invention being mechano-chemical process creates favorable conditions for these forces development on the intermolecular level. R. A. Olson et al. “Interpretation of the impedance spectroscopy of cement paste via computer modeling,” Part III “Micro structural analysis of frozen cement paste,” Journal of material science 30 (1995) 5078-5080, states. That freezing of liquid phase in pores of C—S—H gel begins at −40° C. Both of these sources explain the capability of mechanically activated mortars and mortar component of concrete in accordance with present invention to harden in low temperature conditions under sea water and subzero temperature on the air.

It will be clear that changes in the details, materials, steps and arrangement of parts which have been described and illustrated to explain the nature of the present invention as well as eliminating some of claimed parameters of activation may be made by those skilled in the art upon reading of this disclosure with attaining considerable increase of C—S—H gel and other shown above changes of properties of the activated mixture and in spite of it continue to stay within the principles and scope of present invention.

It will be understood that each of the elements described above, or two or more together, may also find a useful application in other types of method differing from the type described above.

While the invention has been illustrated and described as embodied in a method for producing activated construction mixture, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in appended claims.

### TABLES

TABLE 1
The examples of activated mixtures, general parameters of activation and observations
(average values).

| Test #, | | | | | | | Set. time | | |
|---|---|---|---|---|---|---|---|---|---|
| C/S/W, blade | Activation | ΔP, | | Din. viscosity | | | Acceleration, | Bleeding, % | |
| description | time, sec | watt | N, rps | η, Pa · s | Re | Np | hours | Control. | Activated |
| #8, 1/0.6/0.37 | 188 | 206.1 | 48 | 2.43 | 252 | 0.319 | 3.0 | 1.77 | 0.00 |
| Straight blade | | | | | | | | | |
| #5, 1/2/0.39 | 263 | 122.1 | 28.3 | 4.2 | 110.5 | 0.86 | 7 | 0.83 | 0.00 |
| Straight blade | | | | | | | | | |
| #11, 1/2/0.37 | 1016 | 23.8 | 10.3 | 6.62 | 21.4 | 3.47 | 7 | 0.79 | 0.00 |
| Straight blade | | | | | | | | | |
| #22, 1/3/0.47 | 269 | 121.6 | 28.4 | 1.81 | 111.8 | 0.849 | 5.5 | 1.65 | 0.00 |
| Straight blade | | | | | | | | | |
| #18, 1/4/0.58 | 227 | 148 | 28.2 | 5.312 | 94.14 | 1.074 | 3.5 | 3.73 | 0.00 |
| Straight blade | | | | | | | | | |
| #17, 1/0.33/0.43 | 288 | 80.8 | 49.8 | 0.82 | 777 | 0.1 | 0.0 | 2.71 | 2.70 |
| Skewed blade | | | | | | | | | |
| (tg = 0.65) | | | | | | | | | |
| #19, 1/0.0/0.297 | 355 | 93.57 | 28.6 | 3.22 | 117.2 | 0.7 | 1.3 | 0.464 | 0.177 |
| Straight blade | | | | | | | | | |
| #20, 1/0.0/0.36 | 284 | 115.4 | 49.4 | 1.23 | 529.4 | 0.155 | 2.0 | 0.90 | 0.139 |
| Straight blade | | | | | | | | | |
| blade | | | | | | | | | |

TABLE 1a
Mixtures for the construction purposes

| ## of mixtures | Mortar | Activated | | Tile for | | | | |
|---|---|---|---|---|---|---|---|---|
| according | component | binder | Cellular | roof and | Activated | | Paving | Art |
| Table 1 | of concrete | for concrete | Concrete | siding | mortar | Grout | stones | Works |
| #8 | | + | + | | | + | | |
| #5 | + | | + | + | | + | | + |
| #22 | | | | + | + | | + | |
| #18 | | | | | | | + | |
| #20 | | + | | | | + | | |

TABLE 2
The example of activation process monitoring, including measured and calculated parameters.

| Time, | Power, | Net power, | Temp, | N, | Torque, | Net torque, | ω = 6.28 * N | η, din. visc., | | |
|---|---|---|---|---|---|---|---|---|---|---|
| (s) | (watt) | (watt) | ° C. | (rps) | (N · m) | (N · m) | (rad) | (Pa · s) | Re | Np |
| 0 | 423 | 207.4 | 25 | 22.1 | 3.039 | 1.866 | 139.2 | 13.56 | 22.69 | 2.95 |
| 6 | 400 | 184.4 | 25 | 28.0 | 2.273 | 1.101 | 175.9 | 6.329 | 61.44 | 1.30 |
| 14 | 389 | 173.4 | 26 | 28.1 | 2.204 | 1.032 | 176.5 | 5.914 | 65.95 | 1.21 |
| 20 | 387 | 171.4 | 27 | 28.1 | 2.193 | 1.021 | 176.5 | 5.85 | 66.68 | 1.2 |
| 28 | 388 | 172.4 | 29 | 28.0 | 2.201 | 1.029 | 176.3 | 5.904 | 65.99 | 1.21 |
| 35 | 390 | 174.4 | 29 | 28.0 | 2.213 | 1.04 | 176.3 | 5.969 | 65.27 | 1.22 |
| 42 | 382 | 166.4 | 30 | 28.1 | 2.163 | 0.991 | 176.6 | 5.676 | 68.75 | 1.16 |
| 55 | 373 | 157.4 | 31 | 28.1 | 2.109 | 0.936 | 176.9 | 5.353 | 73.03 | 1.09 |
| 64 | 367 | 151.4 | 33 | 28.2 | 2.071 | 0.899 | 177.2 | 5.129 | 76.36 | 1.04 |
| 79 | 357 | 141.4 | 34 | 28.3 | 2.008 | 0.835 | 177.8 | 4.75 | 82.75 | 0.96 |
| 95 | 348 | 132.4 | 36 | 28.3 | 1.952 | 0.78 | 178.2 | 4.425 | 89.03 | 0.89 |
| 110 | 338 | 122.4 | 37 | 28.4 | 1.894 | 0.722 | 178.5 | 4.09 | 96.45 | 0.82 |
| 136 | 328 | 112.4 | 39 | 28.5 | 1.833 | 0.66 | 179 | 3.731 | 106 | 0.75 |
| 151 | 318 | 102.4 | 40 | 28.5 | 1.773 | 0.6 | 179.4 | 3.384 | 117.2 | 0.68 |
| 165 | 314 | 98.38 | 40 | 28.5 | 1.75 | 0.578 | 179.4 | 3.258 | 121.7 | 0.65 |
| 187 | 301 | 85.38 | 43 | 28.6 | 1.673 | 0.501 | 179.9 | 2.814 | 141.3 | 0.56 |
| 205 | 299 | 83.38 | 45 | 28.6 | 1.66 | 0.487 | 180.1 | 2.737 | 145.5 | 0.54 |
| 215 | 295 | 79.38 | 45 | 28.7 | 1.636 | 0.463 | 180.3 | 2.599 | 153.4 | 0.52 |
| 223 | 289 | 73.38 | 46 | 28.7 | 1.603 | 0.43 | 180.3 | 2.412 | 165.3 | 0.48 |
| 234 | 290 | 74.38 | 46 | 28.7 | 1.606 | 0.434 | 180.6 | 2.43 | 164.2 | 0.48 |
| 246 | 280 | 64.38 | 47 | 28.8 | 1.548 | 0.376 | 180.9 | 2.101 | 190.3 | 0.41 |
| Average | 341 | 125.43 | 25-47 | 28.0 | 1.946 | 0.774 | 176.27 | 4.539 | 104.3 | 0.92 |

TABLE 3
The results of calculation of the production scale activator

| | | | | | | | | Activated mixture | |
|---|---|---|---|---|---|---|---|---|---|
| Activator | Ds, m | Rs, m | Dc, m | Rc, m | L, m | ΔP, wt | N, rps | Mass, kg | vol. cu.m |
| Small Scale | 0.077 | 0.0385 | 0.105 | 0.0525 | 0.024 | 122 | 28.32 | 1.018 | 0.000439 |
| (s.s.) | | | | | | | | | |
| Production | 0.473 | 0.236 | 0.42 | 0.321 | 0.147 | 27788 | 8.556 | 231.7 | 0.1 |
| Scale (p.s.) | | | | | | | | | |

1. A method of producing an activated construction mixture of components including cement, water additives and a superplasticizer with a mechanical activation comprising the steps of introducing the components into an activating assembly providing specific consumed power from 30 to 600 wt/kg and specific energy expenditure from 5 to 400 Kj/kg and mechanically activating the components in the activating assembly; measuring parameters of the mechanical activation and determining dimensionless criteria Reynolds and Power numbers used as a generalized parameters for providing a substantially laminar flow of a mixture of the components during the mechanical activation; and selecting for the mechanical activation said numbers within limits 20-800 and 4.0-0.1 respectively, thus increasing water adsorption with calcium silicate hydrate colloid formation and thereby accelerating cement hydration.

2. A method as defined in claim 1, wherein said introducing and mechanically activating includes introducing the components into the activating assembly having a vessel with a rotating paddle providing the specific consumed power.

3. A method as defined in claim 1, further comprising providing a cement hydration including 3-5° C. under sea water and subzero on air conditions.

4. A method as defined in claim 1, further comprising using as the additives a mineral additive comprising cementitious materials with low hydraulic activity partly substituting cement, ettringite forming additive for shrinkage compensation, and pigments.

5. A method as defined in claim 1, further comprising introducing the superplasticizer at an end of the activation for providing a required flowability of the mixture without bleeding and segregation, and introducing partly during activation for continuation of the activation when an acceleration of water adsorption lowers a mixture flow.

6. A method as defined in claim 1, further comprising using in the mixture also sand with required sand to cement ratio with a partial substitution of cement by a component selected from the groups consisting of fly ash and fly ash with lime; and adding at an end of the activation the superplasticizer and a gas-forming admixture to provide ending of expansion and start setting the activated mixture simultaneously for production of a cellular concrete having a reduced capillary flow.

7. A method as defined in claim 2, further comprising changing a volume of the activated mixture by proportionally changing geometric parameters of the activating assembly while maintaining constant a net specific power and values of the criteria Reynolds and Power numbers for each particular task and mixture.

8. A method as defined in claim 2, further comprising forming the activating assembly as a small scale working prototype of a production scale activating assembly; monitoring a temperature of the activated mixture, power consumption and paddle rotation parameters with and without a mixture by a sensor and measuring devices; and inputting running values of said parameters and geometrical parameters of the activating assembly as constants and outputting running and average values of measured and calculated parameters including net power consumption, apparent dynamic viscosity and the dimensionless criteria Reynolds and Power numbers by a computer device.
